(19) United States
(12) Patent Application Publication
(10) Pub. No.: US 2021/0261037 A1
(43) Pub. Date: Aug. 26, 2021

(54) Boat Centering Assembly

(71) Applicant: Dave Nowak, Beaverton, MI (US)

(72) Inventor: Dave Nowak, Beaverton, MI (US)

(21) Appl. No.: 16/801,620

(22) Filed: Feb. 26, 2020

(51) Int. Cl. B60P 3/10

(52) U.S. Cl. CPC B60P 3/1066

(57) ABSTRACT

A boat centering assembly includes a plate that is mountable to a respective vertical member of a side rail on a boat trailer and a nut that is bonded to the plate. A bolt is extendable through the plate and threadably engages the nut. The bolt is rotatable to extend a preferred distance toward a boat that is positioned on the boat trailer. A panel is coupled to the bolt having the panel being positioned between the respective vertical member of the side rail and the boat on the boat trailer. A block is removably attached to the panel and the block abuts the boat when the bolt is threaded through the nut. A cushioning material is wrappable around the block to contact the boat. The cushioning material is comprised of an abrasion resistant material to inhibit paint on the boat from being damaged by friction with the block.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to boat centering devices and more particularly pertains to a new boat centering device for centering a boat on a boat trailer.

### (2) Description of Related Art Including Information Disclosed Under 37 CFR 1.97 and 1.98

The prior art relates to boat centering devices. The prior art discloses a variety of boat guides, each including a pair of uprights and a roller positioned on each upright, for centering a boat on a boat trailer. The prior art discloses a variety of boat guides for boat trailers that include a planar surface for centering a boat on a boat trailer. The prior art discloses a new boat trailer that has a hinged rear end for enhancing driving a boat onto the boat trailer.

### BRIEF SUMMARY OF THE INVENTION

An embodiment of the disclosure meets the needs presented above by generally comprising a plate that is mountable to a respective vertical member of a side rail on a boat trailer and a nut that is bonded to the plate. A bolt is extendable through the plate and threadably engages the nut. The bolt is rotatable to extend a preferred distance toward a boat that is positioned on the boat trailer. A panel is coupled to the bolt having the panel being positioned between the respective vertical member of the side rail and the boat on the boat trailer. A block is removably attached to the panel and the block abuts the boat when the bolt is threaded through the nut. A cushioning material is wrappable around the block to contact the boat. The cushioning material is comprised of an abrasion resistant material to inhibit paint on the boat from being damaged by friction with the block.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a boat centering assembly according to an embodiment of the disclosure.

FIG. 2 is a front view of an embodiment of the disclosure.

FIG. 3 is a back view of an embodiment of the disclosure.

FIG. 4 is an exploded perspective view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

### DETAILED DESCRIPTION OF THE INVENTION

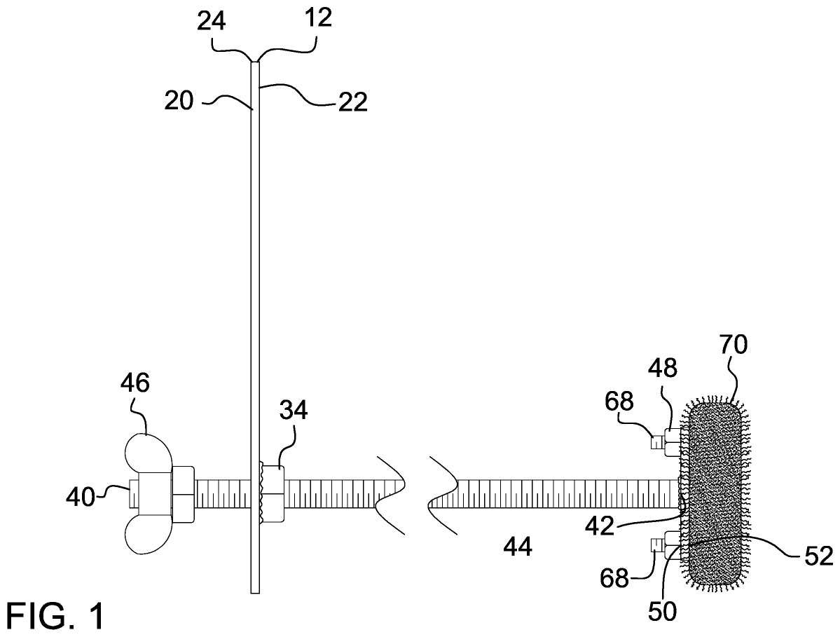

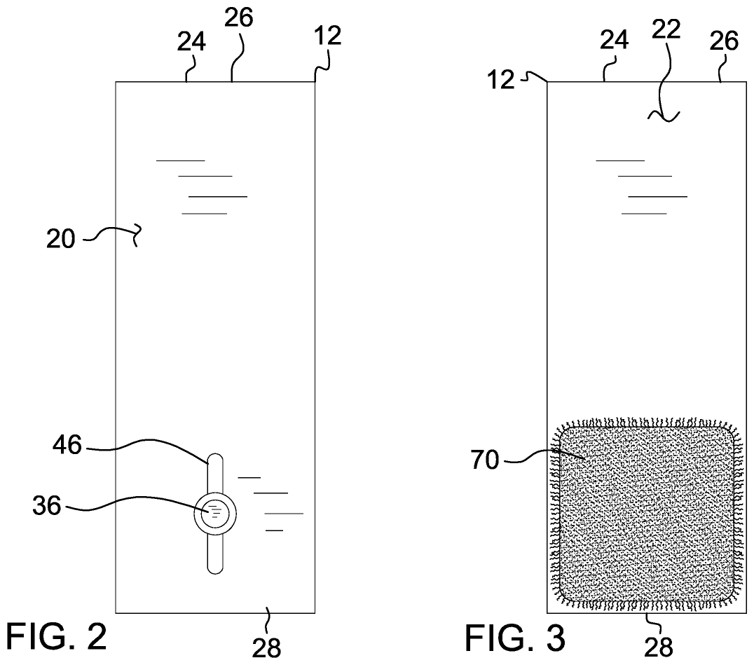

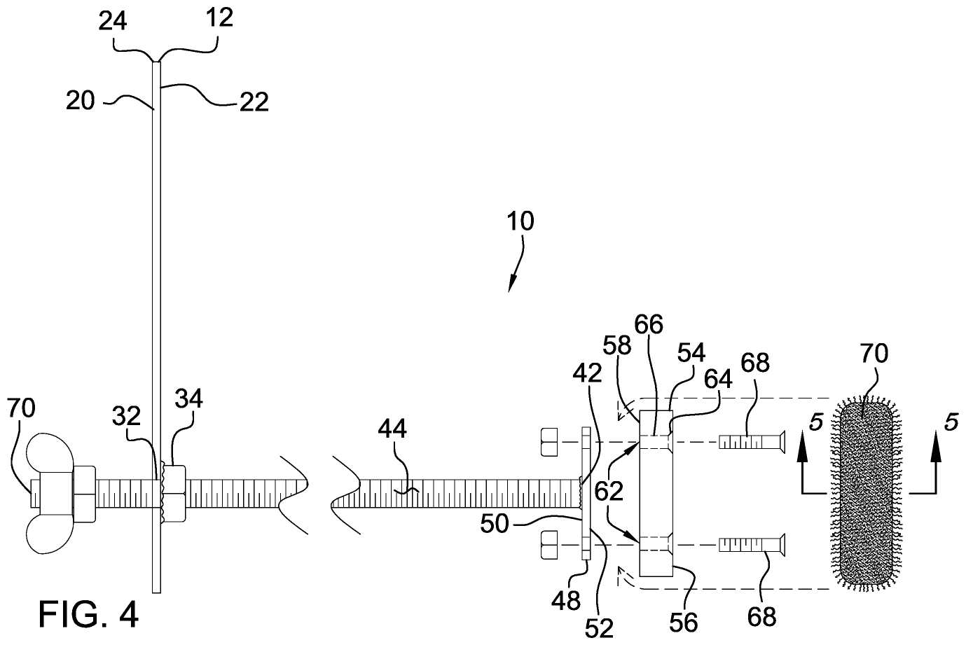

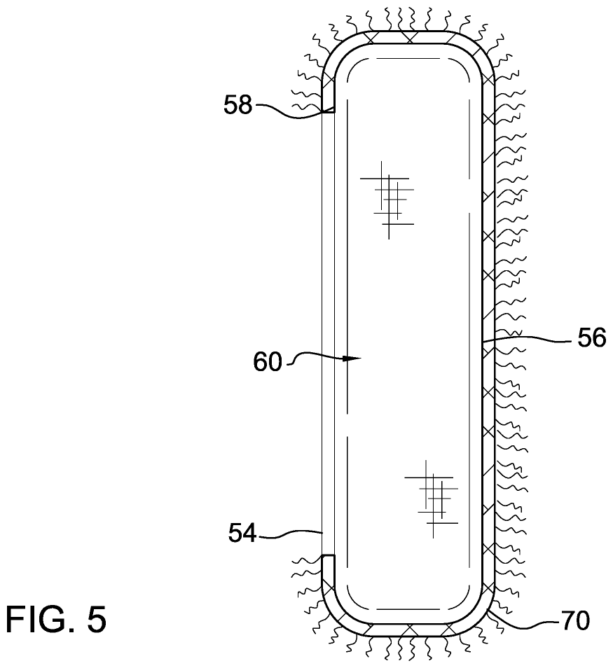

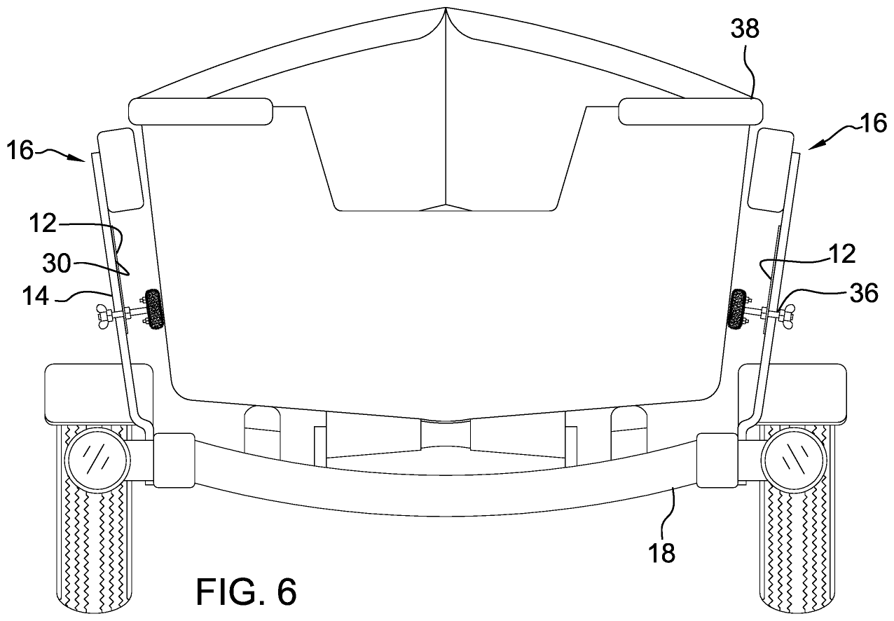

With reference now to the drawings, and in particular to FIGS. 1 through 6 thereof, a new boat centering device embodying the principles and concepts of an embodiment of the disclosure and generally designated by the reference numeral 10 will be described.

As best illustrated in FIGS. 1 through 6, the boat centering assembly 10 generally comprises a plate 12 that is mountable to a respective vertical member 14 of a side rail 16 on a boat trailer 18. The plate 12 has a front surface 20, a rear surface 22 and a perimeter edge 24 extending therebetween, and the perimeter edge 24 has a top side 26 and a bottom side 28. The plate 12 is elongated between the top side 26 and the bottom side 28, and the front surface 20 abuts a boat facing surface 30 of the respective vertical member 14. The plate 12 has a bolt hole 32 extending through the front surface 20 and the rear surface 22 and the bolt hole 32 is positioned closer to the bottom side 28 than the top side 26.

A nut 34 is bonded to the plate 12, the nut 34 is positioned on the rear surface 22 of the plate 12 and the nut 34 is aligned with the bolt hole 32. A bolt 36 is extendable through the plate 12 and threadably engages the nut 34. The bolt 36 is rotatable to extend a preferred distance toward a boat 38 that is positioned on the boat trailer 18. The bolt 36 has a first end 40, a second end 42 and an outer surface 44 extending therebetween, and the outer surface 44 is threaded. The outer surface 44 threadably engages the nut 34 having the second end 42 being directed toward the boat 38. The first end 40 is spaced from the front surface 20 of the plate 12 and the first end 40 has a head 46 thereon. The head 46 abuts the front surface 20 of the plate 12 when the bolt 36 is fully threaded through the nut 34 to inhibit the bolt 36 from passing fully through the plate 12. Moreover, the bolt 36 is extended through the bolt hole 32 in the plate 12.

A panel 48 is coupled to the bolt 36 having the panel 48 being positioned between the respective vertical member 14 of the side rail 16 and the boat 38 on the boat trailer 18. The panel 48 has a primary surface 50 and a secondary surface 52, and the primary surface 50 is bonded to the second end 42 of the bolt 36. A block 54 is removably attached to the panel 48 and the block 54 abuts the boat 38 when the bolt 36 is threaded through the nut 34. The block 54 has a forward surface 56 and a rearward surface 58, and the rearward surface 58 has a well 60 extending toward the forward surface 56.

The block 54 has a pair of fastener apertures 62 each extending through the forward surface 56 and the rearward surface 58. Each of the fastener apertures 62 has a first portion 64 and a second portion 66, and the first portion 64 extends from the forward surface 56 toward the rearward surface 58. The second portion 66 extends from the first portion 64 to the rearward surface 58 and the first portion 64 has a diameter that is greater than the diameter of the second portion 66. The rearward surface 58 abuts the secondary surface 52 of the panel 48.

A pair of fasteners 68 is provided and each of the fasteners 68 extends through the block 54 and engages the panel 48 for retaining the block 54 on the panel 48. Each of the fasteners 68 is extendable through a respective one of the fastener apertures 62 in the block 54 such that the first portion 64 of each of the fastener apertures 62 receives a head 46 of the fastener. In this way the head 46 can be recessed with respect to the forward surface 56 of the block 54. A cushioning material 70 is wrappable around the block 54 to contact the boat 38. Moreover, the cushioning material 70 is comprised of an abrasion resistant material to inhibit paint on the boat 38 from being damaged by friction with the block 54. The cushioning material 70 is wrapped around the forward surface 56 of the block 54 having the cushioning material 70 being tucked into the well 60. In this way the cushioning material 70 is compressed between the rearward surface 58 of the block 54 and the secondary surface 52 of the panel 48. The cushioning material 70 may comprise pile carpet or other similar material that will not abrade the boat 38.

In use, the plate 12 is mounted to the respective vertical member 14 and the bolt 36 is threaded a preferred distance through the nut 34 until the cushioning material 70 abuts the boat 38. As is most clearly shown in FIG. 6, a pair of the plates 12, bolts 36, nuts 34, panels 48 and blocks 54 are provided and each of the pairs are positioned on opposite sides of the boat trailer 18. Thus, the boat 38 will abut the cushioning material 70 on each of the blocks 54 when the boat 38 is driven onto the boat trailer 18. In this way the boat 38 is centered on the boat trailer 18 without requiring adjustment of the boat 38 or multiple attempts at loading the boat 38 onto the boat trailer 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A boat centering assembly being configured to center a boat on a boat trailer, said assembly comprising:
a plate being mountable to a respective vertical member of a side rail on a boat trailer;
a nut being bonded to said plate;
a bolt being extendable through said plate and threadably engaging said nut, said bolt being rotatable to extend a preferred distance toward a boat that is positioned on the boat trailer;
a panel being coupled to said bolt having said panel being positioned between the respective vertical member of the side rail and the boat on the boat trailer;
a block being removably attached to said panel wherein said block is configured to abut the boat when said bolt is threaded through said nut; and
a cushioning material being wrappable around said block wherein said cushioning material is configured to contact the boat, said cushioning material being comprised of an abrasion resistant material wherein said cushioning material is configured to inhibit paint on the boat from being damaged by friction with said block.

2. The assembly according to claim 1, wherein said plate has a front surface, a rear surface and a perimeter edge extending therebetween, said perimeter edge having a top side and a bottom side, said plate being elongated between said top side and said bottom side, said front surface abutting a boat facing surface of the respective vertical member, said plate having a bolt hole extending through said front surface and said rear surface, said bolt hole being positioned closer to said bottom side than said top side.

3. The assembly according to claim 1, wherein said nut is positioned on said rear surface of said plate, said nut being aligned with said bolt hole.

4. The assembly according to claim 3, wherein said bolt has a first end, a second end and an outer surface extending therebetween, said outer surface being threaded, said outer surface threadably engaging said nut having said second end being directed toward the boat, said first end being spaced from said front surface of said plate.

5. The assembly according to claim 4, wherein said first end has a head thereon, said head abutting said front surface of said plate when said bolt is fully threaded through said nut to inhibit said bolt from passing fully through said plate, said bolt being extended through said bolt hole in said plate.

6. The assembly according to claim 4, wherein said panel has a primary surface and a secondary surface, said primary surface being bonded to said second end of said bolt.

7. The assembly according to claim 1, wherein said block has a forward surface and a rearward surface, said rearward surface having a well extending toward said forward surface, said block having a pair of fastener apertures each extending through said forward surface and said rearward surface.

8. The assembly according to claim 7, wherein each of said fastener apertures has a first portion and a second portion, said first portion extending from said forward surface toward said rearward surface, said second portion extending from said first portion to said rearward surface, said first portion having a diameter being greater than the diameter of said second portion.

9. The assembly according to claim 8, further comprising a pair of fasteners, each of said fasteners extending through said block and engaging said panel for retaining said block on said panel, each of said fasteners being extendable through a respective one of said fastener apertures in said block such that said first portion of each of said fastener apertures receives a head of the fastener for recessing the head with respect to said forward surface of said block.

10. The assembly according to claim 7, wherein said cushioning material is wrapped around said forward surface of said block having said cushioning material being tucked into said well thereby facilitating said cushioning material to be compressed between said rearward surface of said block and said secondary surface of said panel.

11. A boat centering assembly being configured to center a boat on a boat trailer, said assembly comprising:
a plate being mountable to a respective vertical member of a side rail on a boat trailer, said plate having a front surface, a rear surface and a perimeter edge extending therebetween, said perimeter edge having a top side and a bottom side, said plate being elongated between said top side and said bottom side, said front surface abutting a boat facing surface of the respective vertical member, said plate having a bolt hole extending through said front surface and said rear surface, said bolt hole being positioned closer to said bottom side than said top side;
a nut being bonded to said plate, said nut being positioned on said rear surface of said plate, said nut being aligned with said bolt hole;
a bolt being extendable through said plate and threadably engaging said nut, said bolt being rotatable to extend a preferred distance toward a boat that is positioned on the boat trailer, said bolt having a first end, a second end and an outer surface extending therebetween, said outer surface being threaded, said outer surface threadably engaging said nut having said second end being directed toward the boat, said first end being spaced from said front surface of said plate, said first end having a head thereon, said head abutting said front surface of said plate when said bolt is fully threaded through said nut to inhibit said bolt from passing fully through said plate, said bolt being extended through said bolt hole in said plate;
a panel being coupled to said bolt having said panel being positioned between the respective vertical member of the side rail and the boat on the boat trailer, said panel having a primary surface and a secondary surface, said primary surface being bonded to said second end of said bolt;
a block being removably attached to said panel wherein said block is configured to abut the boat when said bolt is threaded through said nut, said block having a forward surface and a rearward surface, said rearward surface having a well extending toward said forward surface, said block having a pair of fastener apertures each extending through said forward surface and said rearward surface, each of said fastener apertures having a first portion and a second portion, said first portion extending from said forward surface toward said rearward surface, said second portion extending from said first portion to said rearward surface, said first portion having a diameter being greater than the diameter of said second portion, said rearward surface abutting said secondary surface of said panel;
a pair of fasteners, each of said fasteners extending through said block and engaging said panel for retaining said block on said panel, each of said fasteners being extendable through a respective one of said fastener apertures in said block such that said first portion of each of said fastener apertures receives a head of the fastener for recessing the head with respect to said forward surface of said block; and
a cushioning material being wrappable around said block wherein said cushioning material is configured to contact the boat, said cushioning material being comprised of an abrasion resistant material wherein said cushioning material is configured to inhibit paint on the boat from being damaged by friction with said block, said cushioning material being wrapped around said forward surface of said block having said cushioning material being tucked into said well thereby facilitating said cushioning material to be compressed between said rearward surface of said block and said secondary surface of said panel.
